(19) United States
(12) Patent Application Publication
(10) Pub. No.: US 2013/0197939 A1
(43) Pub. Date: Aug. 1, 2013

(54) SOCIAL HEALTH CARE RECORD SYSTEM AND METHOD

(71) Applicant: Shahid N. Shah, Silver Spring, MD (US)

(72) Inventor: Shahid N. Shah, Silver Spring, MD (US)

(73) Assignee: Netspective Communications LLC, Silver Spring, MD (US)

(21) Appl. No.: 13/740,381

(22) Filed: Jan. 14, 2013

Related U.S. Application Data
(60) Provisional application No. 61/590,914, filed on Jan. 26, 2012.

(51) Int. Cl. G06F 19/00; G06Q 50/22

(52) U.S. Cl. CPC G06F 19/322; G06Q 50/22
USPC 705/3

(57) ABSTRACT

A system for facilitating multi-faceted communication over a network. The system includes a plurality of healthcare related entities connected with a communications network. Each of the plurality of healthcare related entities serve as a source of medical records. The system includes a social health care record data bank (SHRDB) accessible by each of the plurality of entities based on rules and preferences of the entities upon authorization by the SHRDB. The SHRDB includes a processing component capable of executing stored instructions to process the medical records of the entities over the communications network. The SHRDB further includes a repository to store the medical records of the plurality of entities. The system includes a multi-faceted social health care component communicatively coupled to the SHRDB and adapted to be accessible by each of the plurality of entities.

### CROSS-REFERENCE TO RELATED APPLICATIONS

This application claims the benefit of U.S. Provisional Application No. 61/590,914, filed on Jan. 26, 2012, the complete disclosure of which, in its entirety, is hereby incorporated by reference.

### BACKGROUND

1. Technical Field

The embodiments herein generally relate to data management and, more particularly, to healthcare data management systems and methods.

2. Description of the Related Art

Hospitals, caretakers, nursing centers or homes, medical offices, medical centers, or other sources of medical care and entities generally keep medical and demographic or other such records of their patients. These records may include a variety of information such as demographic information of their patients, medical history, diagnostic and pathology reports of their patients, medical reports or prescriptions, or other such information. This information can be used for a variety of purposes by these sources of medical care. A few examples of them are, without limitations, tracking of the patients and their records, billing, historical assessments, integrating with medical devices, remote care, future care taking, telemedicine, proper ongoing medical or health assessment or treatment, or any other similar purpose.

One way to collate and store the medical data is with the use of an electronic health record data bank (EHRDB). These records from various entities can be electronically maintained such as by the electronic health record data bank (EHRDB) in a central system accessible by the entities. The EHRDB may store medical data of the entities and retrieve the data of the respective entities as and when requested by them.

There is a need for an improved system and a method that provides a multi-faceted facility in the EHRDB to interact with several entities simultaneously.

### SUMMARY

In an embodiment, the present disclosure provides a system for facilitating multi-faceted communication over a network. The system includes a plurality of healthcare related entities each with a computing system connected with a communications network. Each of the plurality of healthcare related entities serve as a source of medical records. The system includes a social health care record data bank (SHRDB) accessible by each of the plurality of entities based on rules and preferences of the entities upon authorization by the SHRDB. The plurality of entities subscribe with the SHRDB to create, store, edit, manage or control the medical records. The SHRDB includes a processing component capable of executing stored instructions to process the medical records of the entities over the communications network. The SHRDB further includes a repository included in or coupled to the SHRDB to store the medical records of the plurality of entities. The system includes a multi-faceted social health care component communicatively coupled to the SHRDB and adapted to be accessible by each of the plurality of entities such that the multi-faceted social health care component enables social interaction among the entities and the SHRDB over the communications network for medical records transfer or sharing.

In an embodiment, the present disclosure provides a system for facilitating multi-faceted communication over a network. The system includes a plurality of healthcare related entities each with a computing system connected with a communications network. Each of the plurality of healthcare related entities serve as a source of medical records. The system further includes a social health care record data bank (SHRDB) accessible by each of the plurality of entities based on rules and preferences of the entities upon authorization by the SHRDB. The plurality of entities subscribe with the SHRDB to create, store, edit, manage or control the medical records. The SHRDB includes a processing component capable of executing stored instructions to process the medical records of the entities over the communications network. The SHRDB further includes a repository included in or coupled to the SHRDB to store the medical records of the plurality of entities. The SHRDB further includes a policy controller to authorize and control access of the plurality of entities based on the rules and respective preferences. The SHRDB further includes a report generator to generate medical records and reports based on the generated medical records from the repository based on the request from the plurality of entities. The system further includes a multi-faceted social health care component communicatively coupled to the SHRDB and adapted to be accessible by each of the plurality of entities such that the multi-faceted social health care component enables social interaction among the entities and the SHRDB over the communications network for medical records transfer or sharing. The multi-faceted social heath care component behaves as a centralized application and is adapted to automatically control display of the medical data based on the rules and the preferences. The multi-faceted social health care component is adapted to interact with a first of the plurality of entities such that the first entity receives a purely intermediated care from the SHRDB or in combination with a third party, a second of the plurality of entities such that the second entity receives a purely non-intermediated care from the SHRDB or in combination with a third party, a third of the plurality of entities such that the third entity receives a purely directed care from the SHRDB or in combination with a third party, a fourth of the plurality of entities such that the fourth entity receives a purely undirected care from the SHRDB or in combination with a third party, and a fifth of the plurality of entities such that the fifth entity receives a combination of two or more of the intermediated, non-intermediated, directed, and undirected care from the SHRDB or in combination with a third party.

In an embodiment, the present disclosure provides a method for accessing a social health record data bank (SHRDB) by an entity. The method includes receiving a request from the entity for accessing the SHRDB. The method further includes authenticating the entity. The method further includes determining access rights of the entity based on rules and preferences. The method further includes retrieving medical records from a repository of the SHRDB as requested by the entity in the request. The step of retrieving of the medical records may include at least one of sharing of the medical records either partially or fully to the entity and allowing viewing of the medical records at least partially by the entity. The method further includes determining a type of service to be provided to the entity in association with the sharing of the medical records or allowing viewing of the medical records by the entity. The service includes at least one of a pure intermediated care, pure non-intermediated care, pure directed care, and pure undirected care. The service may be provided by the SHRDB only or in combination with a third party. The request from the entity further includes an instruction to share at least a portion of the medical records to a target location entity. The method may further include sharing the at least a portion of the medical records based on at least one of (a) an explicit or implicit permission from the entity, (b) an indication of the extent of sharing, (c) a nature and characteristic of the target location entity, (d) a purpose of the sharing of the medical records to the target location entity, and (e) a timeframe for allowance of sharing of the medical records. The sharing of the medical records with the target location may include providing viewing rights to the target location such that the method allows partial viewing of the at least a portion of the medical records by the target location based on one or more of (a) to (e), or stop any viewing or select which parts to view based on one or more of (a) to (e), or determine or facilitate the entity to determine who has viewed the medical records.

In an embodiment, the present disclosure provides a non-transitory program storage device readable by computer, and comprising a program of instructions executable by the computer to perform a method for accessing a social health record data bank (SHRDB) by an entity. The method includes receiving a request from the entity for accessing the SHRDB. The method further includes authenticating the entity. The method further includes determining access rights of the entity based on rules and preferences. The method further includes retrieving medical records from a repository of the SHRDB as requested by the entity in the request. The step of retrieving of the medical records may include at least one of sharing of the medical records either partially or fully to the entity and allowing viewing of the medical records at least partially by the entity. The method further includes determining a type of service to be provided to the entity in association with the sharing of the medical records or allowing viewing of the medical records by the entity. The service includes at least one of a pure intermediated care, pure non-intermediated care, pure directed care, and pure undirected care. The service may be provided by the SHRDB only or in combination with a third party. The request from the entity further includes an instruction to share at least a portion of the medical records to a target location entity. The method may further include sharing the at least a portion of the medical records based on at least one of (a) an explicit or implicit permission from the entity, (b) an indication of the extent of sharing, (c) a nature and characteristic of the target location entity, (d) a purpose of the sharing of the medical records to the target location entity, and (e) a timeframe for allowance of sharing of the medical records. The sharing of the medical records with the target location may include providing viewing rights to the target location such that the method allows partial viewing of the at least a portion of the medical records by the target location based on one or more of (a) to (e), or stop any viewing or select which parts to view based on one or more of (a) to (e), or determine or facilitate the entity to determine who has viewed the medical records.

### BRIEF DESCRIPTION OF THE FIGURES

In the drawings, like numerals describe similar components substantially throughout the several views. The drawings illustrate generally, by way of an example, but not by a way of limitation, various embodiments.

FIG. 1 illustrates generally, but not by the way of limitation, among other things, a schematic diagram depicting a communications environment, in which some embodiments herein may operate;

FIG. 2 illustrates generally, but not by the way of limitation, among other things, an example of an interactive social users interface display of a multi-faceted social health care component;

FIGS. 3A and 3B illustrate generally, but not by the way of limitation, a sequence diagram depicting a method for restricting access to the multi-faceted social health care component based on the determined policy-based restrictions;

FIG. 4 illustrates generally, but not by the way of limitation, among other things, a schematic diagram depicting a communications environment, in which some embodiments herein may operate;

FIG. 5 illustrates a method flowchart for accessing a social health care component by an entity; and

FIG. 6 illustrates a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings that form a part hereof, and these are shown by way of illustrating specific embodiments herein that may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

In this document, the terms “a” or “an” are used, as is common in patent documents, to include one or more than one. In this document, the term “or” is used to refer to a “nonexclusive or” unless otherwise indicated.

The embodiments herein provide a method and system for creating, controlling and managing portions of health care records more specifically electronic health care records via a multi-faceted social health care component to enable social interaction among one or more entities (hereafter entities). The multi-faceted social health care component is configured to allow collaboration and interaction among the entities through a Social Health Record Data Bank (SHRDB). The SHRDB can be configured to provide a repository for the storage of a plurality of such as electronic healthcare records generated by the entities. The various portions of the multi-faceted social health care component can be accessed by the entities based on entity specific preferences and roles. In accordance with some embodiments, the entities may be communicatively connected among themselves. For example, the entities can interact through emailing, Instant Messaging, or various other modes. In some embodiments, the entities can connect or interact among themselves even without going through the SHRDB (thus bypassing the SHRDB).

In an embodiment, the medical records or health records can be social health records or social records simply. The social health records referred herein can be understood as medical records stored in a central storage database such as the SHRDB. In another embodiment, the social health records referred herein can be understood as medical records collected from several distinct locations such as several social aware networks or applications and brought at a single location such as the SHRDB. The social records thus collected and integrated at the single location can further be distributed socially among several entities such as users individually or through social networks or applications. Therefore, the present system and method provides a mechanism for two way communication between several entities and the social aware networks wherein the records can be collected from the social aware networks or applications as well as distributed toward the social aware networks or applications. In such embodiments, the social records can be considered as the medical records floated over a network for allowance toward such a two way communication.

In various embodiments discussed below, the terms ‘medical records’, ‘health records’, ‘social records’, ‘electronic records’, ‘medical health records’, ‘social health records’ are interchangeably used without limitations. The terms entities and users are used interchangeably without limitations. The terms social aware network, and social network are used interchangeably without limitations.

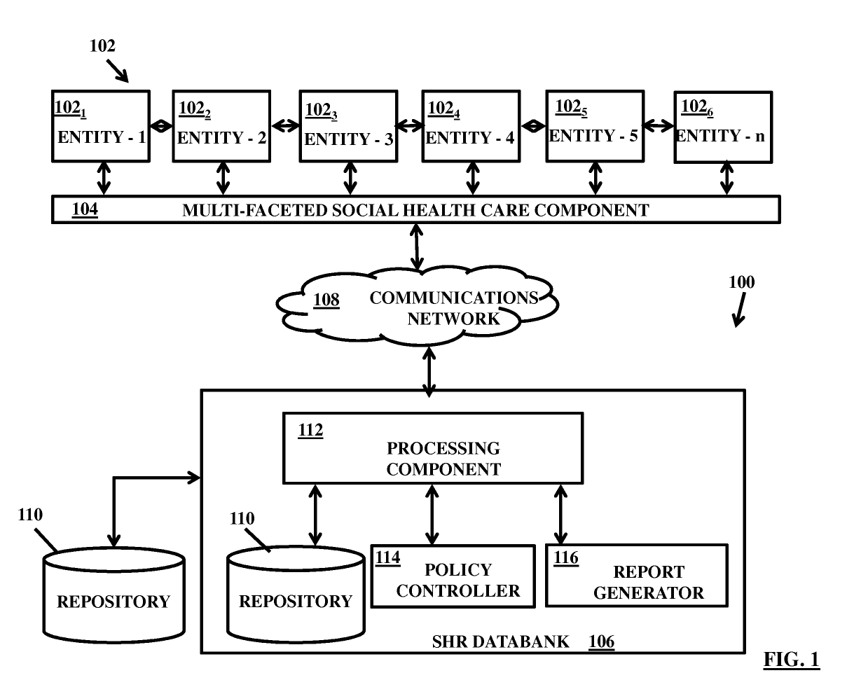

FIG. 1 illustrates generally, but not by the way of limitation, among other things, a schematic diagram depicting a communication environment 100, in which at least some embodiments herein may operate. The environment 100 provides a high-level view of one or more entities 102₁₋₆ (hereafter entities 102 referred, in general) communicating with a multi-faceted electronic health care component 104 provided by a Social Health Record Data Bank (SHRDB) 106 over a communications network 108.

The entities 102 may include a healthcare related entity with a computing system connected to the communications network 108. Further, an “entity” is understood to mean an individual such as for whom data is managed or who manages data in the SHRDB 106. The entities 102 may include, but not limited to a patient, clinician or doctor, a research organization, a biller, a hospital, an insurance corporation, an emergency resource such as ambulance, a marketer, an advertiser, an enterprise, a sponsor, an office professional or any other individual. More generally, each of the entity 102 can access the multi-faceted social health care component 104 to view, control, and manage healthcare related goods or services for which a plurality of electronic heath care records may be generated and deposited with the SHRDB 106.

In some embodiments, the SHRDB 106, described herein, may be centralized, for example with the use of a centralized server including in or coupled to a repository 110. The repository 110 can store the plurality of electronic heath care records including data or information related to the entities. The data can be organized in a way that facilitates local or remote information retrieval in the communication network 108 via a processing component 112. In some embodiments, the processing component 112 can be, but not limited to, a microprocessor, a microcontroller, or an equivalent mechanism. The processing component 112 may be capable of executing stored instructions to process data over the communications network 108. The data corresponding to an individual entity may or may not have been derived from medical testing or treatment (e.g., the data may have been derived from a research organization trial in which the individual voluntarily participated or data may have been derived from insurance services or any other source). More generally, “electronic heath care records” may include data related to doctor's visits, lab tests, hospital stays, clinical trials, patient problems, patients health information, patient habits, patient medical history, patient appointments, patient medical insurance, patient medical bills status, or any other information.

The entities 102 subscribe or register with the SHRDB 106 to create, view, edit, manage, and control the plurality of health care records via the multi-faceted social health care component 104. The SHRDB 120 stores the information about the entities 102 in a policy controller 114. The information described herein can be related to the role of the entities 102, preferences of the entities 102 or any other information. The policy controller 114 includes one or more rules to control an access to the multi-faceted social health care component 104 based on the roles and preferences of the entities 102. The policy controller 114 interacts with the processing component 112 to control access of the entities 102 to the electronic health care records. In an embodiment, the policy controller 114 is configured to generate an output based on the rules defined, and roles and preferences of the plurality of entities 102, upon receipt of a request from an entity such as 102₁ for accessing the SHRDB 106. The output is a function dependent on such as the rules, roles and the preferences. In an embodiment, the processing component 112 can evaluate the value of the output. In an embodiment, the function can be subjectively defined. In another embodiment, the function can be mathematically and analytically defined such that upon receipt of values of the concerned rules, roles and the preferences corresponding to a particular entity 102₁, the value of the function that is indicative of the output may be evaluated by the processing component 112. In such embodiments, the rules, and roles and the preferences may also be defined through a mathematical function such as based on statistical tools, scaling or rating techniques, or in the form of any other mathematical expression. The output generated either through a subjective approach or an objective or a mathematical approach may be used by the multi-faceted social health care component 104 to authorize and control access of the plurality of entities 102. In an embodiment, the multi-faceted social health care component 104 is communicatively coupled to the SHRDB 106 and adapted to be accessible by each of the plurality of entities 102 such that the multi-faceted social health care component 104 enables social interaction among the entities 102 and the SHRDB 106 over the communications network 108 for medical records transfer or sharing. The multi-faceted social heath care component 104 behaves as a centralized application and is adapted to automatically control display of the medical data or records based on the rules and the preferences.

The SHRDB 106 can be coupled to a report generator 116 that may generate health care reports and share them with the entities 102 periodically. In an embodiment, the reports can further be approved by the policy controller 114 before sharing with the plurality of entities 102.

The multi-faceted social health care component 104 may be a web-based interface displaying customized graphical interface enabling social interaction among the entities 102 over the communication network 108 The communications network 108 described herein may be the Internet. The multi-faceted social health care component 104 can be a centralized application or component that automatically controls display of the electronic health records based on the rules defined in the policy controller 116 of the SHRDB 106.

As described above also, in accordance with some embodiments, the entities 102 may be communicatively connected among themselves. For example, the entities 102 can interact through emailing, Instant Messaging, or various other modes. In some embodiments, the entities 102 can connect or interact among themselves even without going through the SHRDB 106 (thus bypassing the SHRDB 106). In some embodiments, identifiers may be used during communication among the entities 102 to enable a secured communication.

In accordance with some embodiments, the interaction of the entities 102 with the SHRDB 106 can be intermediated such that an external entity such as a different hospital, health care provider (who may be one of the entities 102 as illustrated in various figures) can operate as an intermediary among the entities 102 and the SHRDB 106. In such cases, a request such as to access the SHRDB 106 or for any other purpose may be routed via the external entity. For this, the external entity can be paid for the respective services delivered by the external entity. It must be understood that the term “external” as used herein in conjunction with defining the “external entity” is merely exemplary. However, the “external entity” can be a part of the entities 102 or may be an entity external from the group of entities 102 as illustrated in various figures.

In accordance with some embodiments, the interaction of the entities 102 with the SHRDB 106 can be non-intermediated such that no external entity such as a different hospital, health care provider, and the like operates as an intermediary between the entities 102 and the SHRDB 106. In such cases, the entities 102 can directly communicate with the SHRDB 106.

In accordance with some embodiments, the mode of interaction of the entities 102 with the SHRDB 106 can be of the type of “directed” in which an external entity similar to the external entity described above may provide a directed care to the entities. In such cases, the external entity can be paid for the directed care that it provides to the entities 102. In case of a directed type of interaction, the external entity may provide directed care, or may provide instructions to the entities 102, or monitor instructions being followed by the entities 102, or generate reports and share them with the entities 102, and the like.

In some embodiments, the interaction of the entities 102 with the SHRDB 106 can be of the type of “undirected” in which no external entity similar to the external entity described above is involved to provide a directed care.

In some embodiments, the mode of operation and interaction can be purely intermediated, purely non-intermediated, purely directed, purely undirected, or a combination thereof. In some embodiments, the mode of interaction may be customized for each of the entities 102. For example, an entity such as the entity 102₁ may receive an intermediated care while the entity 102₂ may receive a non-intermediated care.

In an embodiment, the plurality of entities 102 may include such as a first entity 102₁, a second entity 102₂, a third entity 102₃, a fourth entity 102₄, and a fifth entity 102₅. In an aspect, the first entity 102₁ receives a purely intermediated care from the SHRDB 106 or in combination with the third party. The second entity 102₂ receives a purely non-intermediated care from the SHRDB 106 or in combination with the third party. The third entity 102₃ receives a purely directed care from the SHRDB 106 or in combination with the third party. The fourth entity 102₄ receives a purely undirected care from the SHRDB 106 or in combination with the third party. The fifth entity 102₅ receives a customized service with a combination of two or more of the intermediated, non-intermediated, directed, and undirected care from the SHRDB 106 or in combination with the third party.

In an embodiment, the multi-faceted social health care component 104 is adapted to interact with the first entity 102₁ of the plurality of entities 102 such that the first entity 102₁ receives a purely intermediated care from the SHRDB 106 or in combination with a third party, the second entity 102₂ of the plurality of entities 102 such that the second entity 102₂ receives a purely non-intermediated care from the SHRDB or in combination with a third party, the third entity 102₃ of the plurality of entities 102 such that the third entity 102₃ receives a purely directed care from the SHRDB 106 or in combination with a third party, a fourth entity 102₄ of the plurality of entities 102 such that the fourth entity 102₄ receives a purely undirected care from the SHRDB 106 or in combination with a third party, the fifth entity 102₅ of the plurality of entities 102 such that the fifth entity 102₅ receives a combination of two or more of the intermediated, non-intermediated, directed, and undirected care from the SHRDB 106 or in combination with a third party.

In an embodiment, the multi-faceted social health care component 104 is configured to identify at least one source location and a target location upon receipt of a request from an entity such as 102₁. The source location is defined as at least a portion of the medical records that is requested by an entity 102₁ that sends a request to the SHRDB 106 to such as view or receive at least a portion of the medical records or allow another entity such as 102₂ or any other entity to view or receive the at least a portion of the medical records. In another words, the source location specifies the at least a portion of the medical records. The target location or the target location entity is defined as an entity that is authorized by the request sending entity through the request to view or receive at least the portion of the medical records (that is the source location). The target location entity such as 102₂ thus serves as a recipient entity of the at least a portion of the medical records or the source location. The target location 102₂ may be identified by such as one or more of (a) an explicit or implicit permission from an owner of the source location such as an owner of the at least a portion of the medical records such as 102₁, (b) an indication of the extent of sharing that is the extent and nature of the medical records or the source location, (c) a nature and characteristic of the target location 102₂, (d) a purpose of the sharing of the medical records to the target location 102₂, and (e) a timeframe for allowance of sharing of the at least a portion of the medical records. In an aspect, for example, the request sending entity 102₁ may define a specific name and identifier of the target location entity 102₂ in the request such as through an implicit or explicit permission from the owner 102₁ of the source location such as the owner 102₁ of the at least a portion of the medical records and thus the target location 102₂ can be identified and defined from the request. In an aspect, the owner entity 102₁ may send the request including a rule or may predefine a rule providing details about the entities who can be allowed to access a defined portion of the medical records and to a defined extent. The owner entity 102₁ can in such case define such as an indication of the extent of sharing that may vary for different target entities. The target location 102₂ can thus be defined or identified by the SHRDB 106. In another aspect, the owner entity 102₁ may define a rule for sharing of the at least a portion of the medical records such as based on the nature and characteristics of the target location 102₂. For example, a particular owner 102₁ of the at least a portion of the medical records may define a rule such that only hospitals can access a defined portion of the medical records, while any research institute may no access, and the like. In another aspect, the purpose of the sharing may also govern the identification of the target location 102₂ for example an owner entity such as 102₁ may define that a particular portion of the medical records may be accessed only for the purpose of nursing and surgical care, and not for research purposes, and the like. In another aspect, the target location 102₂ may be defined based on a timeframe for allowance of sharing of the medical records. For example, an owner entity 102₁ may allow a particular target location 102₂, through such as the request or by predefining, to access the at least a portion of the medical records for a predefined period of time only. In some embodiments, only one of the (a) to (e) may govern identification of the target location 102₂. In another embodiment, more than one of the (a) to (e) may govern selection or identification of the target location 102₂. In an embodiment, the parameters (a) to (e) may be defined mathematically through a mathematical function and statistical tools such that any target location such as 102₂ may be evaluated for various variables based on the parameters (a) to (e) to determine a cumulative effect numerical value for assessing the level of sharing of the medical records, if any. The function considering the impact of the (a) to (e) may be evaluated by such as the processing component 112. In an embodiment, the target location 102₂is automatically determined based on one or more of (a) to (e) upon receipt of the request from the owner entity 102₁ or is predefined within the SHRDB 106 by the owner entity 102₁.

In an embodiment, in addition to alternatively, the source location may also be defined based on and may be dependent on such as the parameters (a) to (e) or any other parameter.

In an embodiment, the sharing of the at least a portion of the medical records with the target location 102₂ may include providing viewing rights to the target location 102₂. In this embodiment, the SHRDB 106 may be configured to allow partial viewing of the medical records corresponding to the owner entity 102₁ by the target location 102₂based on the one or more of (a) to (e), and based on the request from the owner entity 102₁ or based on predefined rules by the owner entity 102₁. In an embodiment, the SHRDB 106 may be configured to stop any viewing or select which parts to be viewed by the target location 102₂ based on the one or more of (a) to (e) and based on the request from the owner entity 102₁ or based on predefined rules by the owner entity 102₁. In an embodiment, the SHRDB 106 may be configured to determine or facilitate the owner entity 102₁ of the medical records to determine who has viewed the medical records. Based on such as knowing who has viewed the medical records, the owner entity 102₁ may redefine or may be facilitated by the SHRDB 106 to accordingly redefine the one or more of the (a) to (e). The owner entity 102₁ may also accordingly make a decision or may be facilitated by the SHRDB 106 to make a decision about the partial viewing of the medical records (that is the source location) corresponding to the owner entity 102₁ by the target location 102₂ based on the redefined one or more of (a) to (e). In an embodiment, the owner entity 102₁ may also accordingly make a decision or may be facilitated by the SHRDB 106 to make a decision about the stopping of any viewing or selecting which parts to be viewed of the medical records (that is the source location) corresponding to the owner entity 102₁ by the target location 102₂ based on the redefined one or more of (a) to (e).

In an embodiment, the social health care component 104 of the SHRDB 106 is configured to identify who has viewed the medical records in real time and share information about who has viewed the medical records with the owner 102₁ in real time, such that the owner 102₁ allows fully or partially or stops viewing of the medical records by the target location 102₂ in real time. In an embodiment, the allowance or denial by the owner 102₁ is performed manually such as without predefining rules and guidelines for allowance and denial. In accordance with such embodiments, the owner entity 102₁ can be facilitated to control viewing rights of the at least a portion of the medical records it owns without predefining any rules. For example, the owner 102₁ may initially allow access to any of the plurality of entities 102 and then receive information from the SHRDB 106 about who has viewed the medical records. Based on such as who has viewed the medical records and further information about who has viewed the medical records and also the purpose of viewing of the medical records, the owner entity 102₁ may decide as to whether the owner entity 102₁ should allow at least partial viewing of the at least a portion of the medical records by other entities such as 102₂ or stop viewing. This may be decided in association with such as the parameters (a) to (e).

In an embodiment, during the time of initial accessing of the at least a portion of the medical records and the time the owner entity 102₁ decides whether to allow viewing or stop viewing the medical records by the entities, the owner entity 102₁ may be facilitated by the SHRDB 106 to allow other entities to view a portion of the at least a portion of the medical records as defined by the owner entity 102₁ referred to as ‘no objection segment’ of the at least a portion of the medical records. The ‘no-objection’ segment for example may refer to some non-confidential or superficial details of the medical records, in an embodiment, and not any detailed or confidential data. In an embodiment, the ‘no-objection’ segment of the medical records can be allowed to be viewed by the entities such as 102₂ for a defined period of time after initiation of viewing by the entities. In an aspect, if the owner entity 102₁ decides about allowance or denial of further viewing of the medical records in addition to the ‘no-objection’ segment in a time that is less than the defined time for the ‘no-objection’ segment viewing, then the decision of allowance or denial can be implemented to either allow further viewing by the entities beyond the ‘no-objection’ segment in case of allowance, or stop further viewing in case of denial, or allow to view only the ‘no-objection’ segment. In such embodiments where the time to allow or deny the viewing beyond the ‘no-objection segment’ is less than the defined time, then the ‘no-objection’ segment viewing may be converted to viewing as decided or authorized by the owner 102₁. If the time to allow or deny the viewing beyond ‘no-objection’ segment is more than the defined time then the ‘no-objection’ segment viewing time may be extended by the owner 102₁ by allowing more of medical records under ‘no objection’ to be viewed or repeating a previously viewed ‘no-objection’ segment of the medical records. The defined time associated with the ‘no-objection’ viewing and the portion of the medical records corresponding to the ‘no objection’ viewing may be further defined by the owner entity 102₁ automatically or manually based on such as one or more of the parameters (a) to (e) or any other parameter.

The connections connecting the various entities 102 as shown in FIG. 1 are merely to illustrate the possibility of the entities 102 to interact among themselves. This should not be considered to limit the entities 102 to be located at a single place or directly connected. A direct connection or singly located may not necessarily be true, however possible. The entities 102 may still be located remotely and communicate through wired mode or wireless mode.

In some embodiments, the multi-faceted social health care component 104 may also be referred to as a multi-faceted electronic health care component. Similarly, the SHRDB 106 may also be referred to as EHRDB (Electronic Health Record Databank).

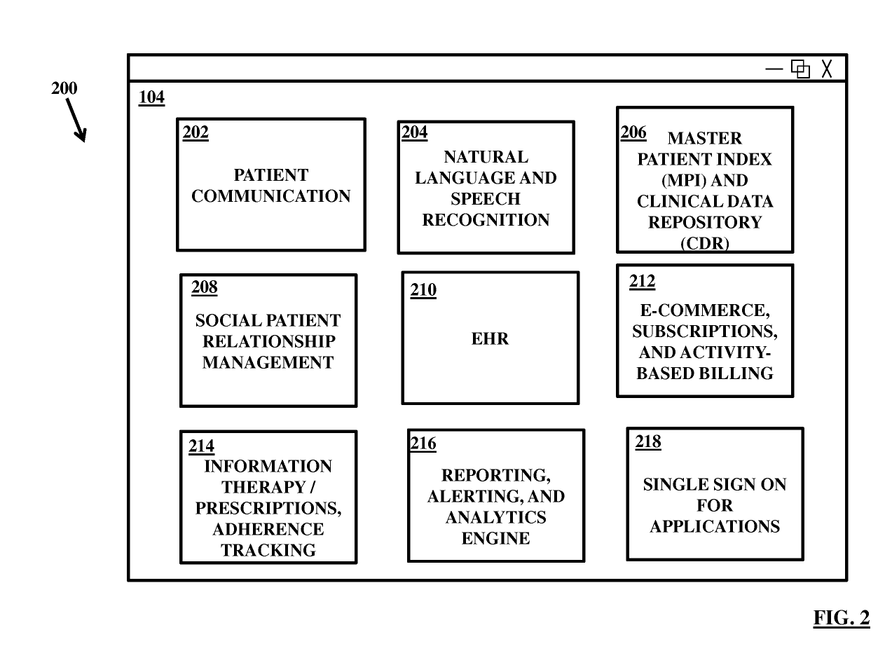

FIG. 2 illustrates generally, but not by the way of limitation, among other things, examples of an interactive social user interface 200 of the multi-faceted social health care component 104. The multi-faceted social health care component 104 may communicate with the SHRDB 106 to provide information related to the entities 102. The interface 200 provides display of different modules 202-218 to different entities 102, such that a social cloud among the different entities 102 may be formed to actively interact with each other via the multi-faceted social health care component 104. Restricted access and display of these modules 202-218 may be provided to the entities 102 based on their specific roles and policies implemented by the SHRDB 106 for respective entities 102.

The modules 202-218 may provide different features and information to the entities 102. In some embodiments, the module 202 which is patient communication may facilitate the entities 102 to socially communicate with each other. For example, the module 202 may provide active social communication among the entities 102 via SMS, Instant Messaging (IM), Email, Voice communication, Video conferencing and the like modes. The module 202 may provide different ways and options to the entities 102 for active social communication, such that a social cloud or platform may be implemented to communicate among the different entities 102. In some embodiments, the multi-faceted social health care component 104 may facilitate the entities 102 to actively interact with each other via a natural language and/or speech recognition techniques via the module 204. The module 206 may provide the entities 102, particularly the entities such as doctors and research organizations with master patient index and clinical data repositories such that the entities 102 may view and use the information related to different patients.

The multi-faceted social health care component 104 includes a module 208 that deploys or employs social entity (such as a patient) relationship management techniques that may help in building long-term relationships, such that the entities 102 specifically clinicians can establish ongoing relationships with their patients. The module 210 may display health records such as electronic health records of the entities 102. In accordance with various embodiments, the module 210 can provide different types of information to the entities 102 based on their specific roles and policies.

The multi-faceted social health care component 104 may also include a module 212 for performing secure electronic transactions. The module 212 may facilitate the entities 102 to pay their medical bills, or purchase any health related products. With the use of a module 214, the multi-faceted social health care component 104 may keep a track of therapies and medical prescription of different patients and constantly display the tracked information to the doctors, clinicians or other entities via the module 214. The multi-faceted social health care component 104 may allow the entities 102 to generate reports of the electronic health information or any other information via the module 216. The module 216 may also display alerts defined from the electronic health information of the entities 102. The module 216 may also deploy analytics processing techniques for analyzing patient information to generate reports and charts.

The multi-faceted social health care component 104 also includes a module 218 to provide a single sign-on interface for a plurality of and different social electronic applications such as Gmail™, Yahoo™, Facebook™, Twitter™ and the like. The SHRDB 106 integrates the entities 102 with social electronic applications and may provide single sign on feature to the entities 102, such that the entities 102 can interact with the multi-faceted social health care component 104 via the social electronic applications.

The above described modules 202-218 are not described by the way of limitation but merely for exemplary purposes for some embodiments herein. In accordance with various other configurations, many such or other types of modules can be integrated within the embodiments herein. The interface 200 of the multi-faceted social health care component 104 may be customized to display the above described modules based on the entities role and policies defined by the SHRDB 106.

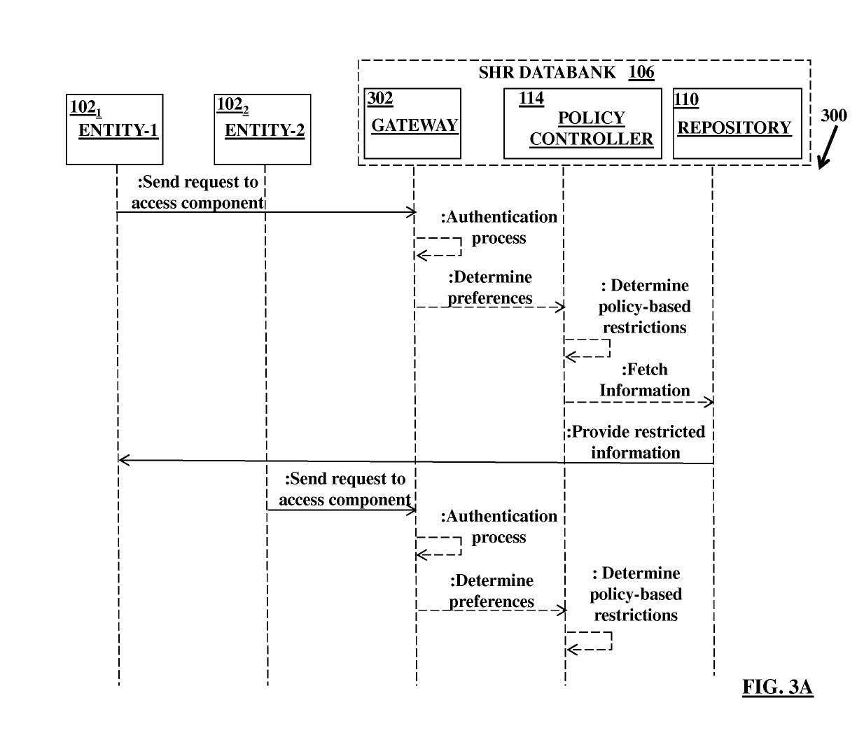

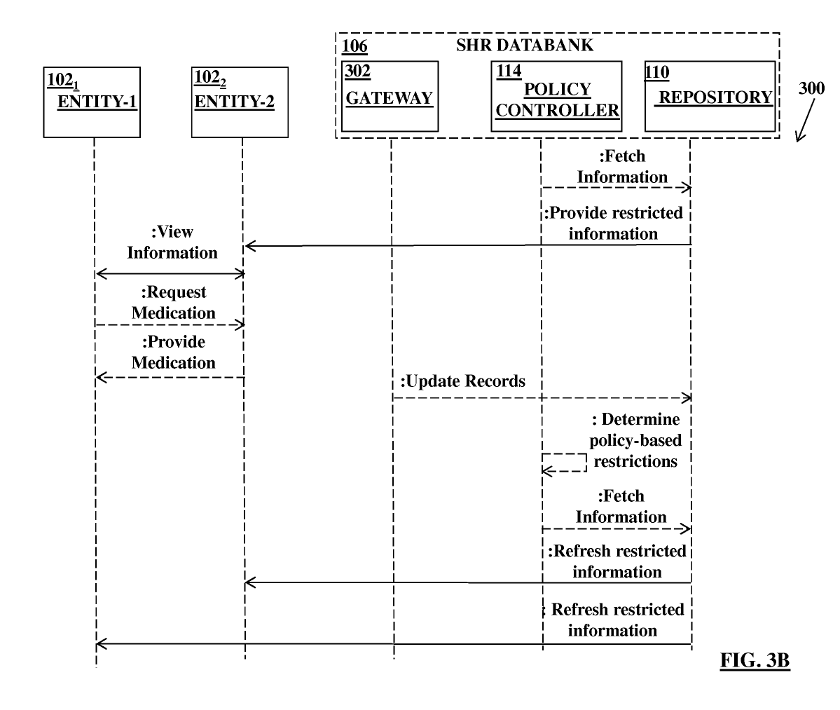

FIGS. 3A and 3B illustrate generally, but not by the way of limitation, a sequence diagram depicting an example of a method 300 for defining access to policy-controlled portions of the multi-faceted social health care component 104. In various embodiments, the multi-faceted social health care component 104 can facilitate the entities 102 to socially interact with one another.

The entities 102 may use the communication network 108 to access the multi-faceted social health care component 104. The multi-faceted social health care component 104 may provide access to the SHRDB 106 to allow the entities 102 to socially interact with the SHRDB 106. For example, an entity such as the entity 102₁ may send a request to access the multi-faceted social health care component 104. The SHRDB 106 may allow the entity 102₁ to access the multi-faceted social health care component 104 via a gateway 302 such as a web page. The gateway 302 may restrict and/or grant access to the multi-faceted social health care component 104 based on the account information such as user name and password of the entity 102₁. For example, the page may prompt the entity 102₁ connecting to the multi-faceted social health care component 104 for a user name and a password if the gateway 302 is an internet page.

In some embodiments, the SHRDB 106 may authenticate the entity 102₁ based on a defined criterion. Once authenticated, the SHRDB 106 may use the policy controller 114 to determine the role and preferences of the entity 102₁ The policy controller 114 may determine restrictions to the portions such as various modules of the multi-faceted social health care component 104 (as described above) based on stored preferences related to the role of the entity 102₁. The SHRDB 106 may send a request to retrieve information from the repository 110. The SHRDB 106 may also customize the interface 200 of the multi-faceted social health care component 104 in accordance with the various policies related to the role of the entity 102₁. The SHRDB 106 may customize the interface 200 of the multi-faceted social health care component 104 in accordance with the determined policy-based restrictions/access related to the entity 102₁.

In some embodiments, another entity such as the entity 102₂ may also access the multi-faceted social health care component 104, such that the entity 102₁ and the entity 102₂ may interact with each other also. The SHRDB 106 can allow the entity 102₁ and the entity 102₂ to view the information of each other and interact with each other via the multi-faceted social health care component 104, which may result in forming the social cloud among the entities 102₁ and 102_{2.} The above description is provided with an example with respect to the entity 102₁ and the entity 102_{2.} Similarly, various other entities 102 may also interact among themselves.

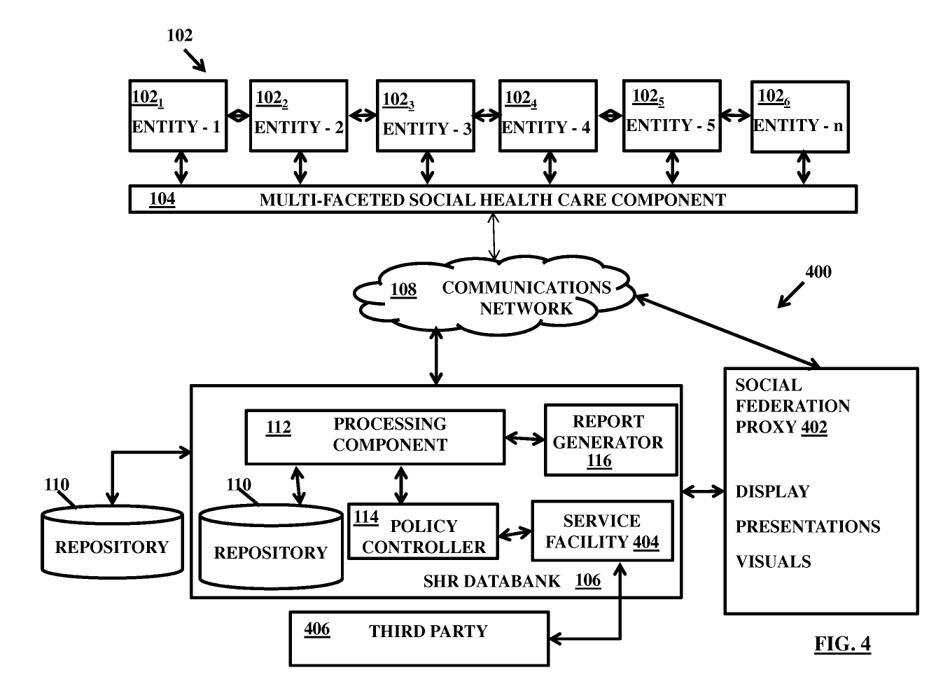

FIG. 4 illustrates generally, but not by the way of limitation, among other things, a schematic diagram depicting a communication environment 400, in which at least some embodiments herein may operate. The environment 400 provides a high-level view of the one or more entities 102 communicating with the multi-faceted electronic health care component 104 provided by the Social Health Record Data Bank (SHRDB) 106 over the communications network 108 in another embodiment. In accordance with the embodiment illustrated in FIG. 4, a social federation proxy 402 is coupled to the SHRDB 106 or a server hosting the SHRDB 106. The social federation proxy 402 is configured to retrieve relevant portions of the medical records or social records from the SHRDB 106 associated with an entity such as the entity 102₁ upon a request from the entity 102₁. While the SHRDB 106 is configured to store and manage the social records corresponding to the plurality of entities 102, the social federation proxy 402 does not generally store the social records. The social federation proxy 402 provides a virtual view of the storage to the entities 102. The social federation proxy 402, upon retrieval of the social records from the SHRDB 106, can display or present them to the entities 102 upon request from the entities 102 such that the viewers get a feel as if they are viewing or accessing the SHRDB 106 directly. With this implementation, the social federation proxy 402 does not behave as a storage facility, instead, provides a virtual platform for the entities 102 to such as view the displayed or presented social records as requested by them through such as displays, presentations, visuals, graphics, and the like. The social federation proxy 402 pulls the social records from the SHRDB 106 for presentation, display, and the like instead of storage.

In an embodiment, the social federation proxy 402 allows the two way communication between the entities 102 and the SHRDB 106. For example, the SHRDB 106 can collect the social records from several social aware networks or applications such as through the entities 102 that are associated with the several social aware networks or the applications. The collected social records can be stored in a physical storage of the SHRDB 106. The social records thus stored in the SHRDB 106 can further be retrieved by the entities 102 and thus distributed across the various social aware networks or the applications through the social federation proxy 402. The entities 102 can enjoy the facility of integration, distribution and retrieval of the social records all at the same time through social aware networks or the applications without even knowing that the access is or the social records are routed through two different levels—social federation proxy 402 and the SHRDB 106. In some embodiments, a virtualization layer may be provided to create a virtual environment that is capable of allowing the entities 102 to share their social records from the social aware networks or the applications and also view or retrieve the social records from the social federation proxy 402 hiding the difference between the social federation proxy 402 and the SHRDB 106 from the entities 102.

In an embodiment, a service facility 404 may be provided with the SHRDB 106. The service facility 404 may be configured to provide various services such as intermediated care, non-intermediated care, directed care, undirected care, and custom care to the entities 102. The services can be provided by the SHRDB 106 directly. In another embodiment, the SHRDB 106 can be connected to a third party 406 such as to provide the various services either through or in combination with the third party 406.

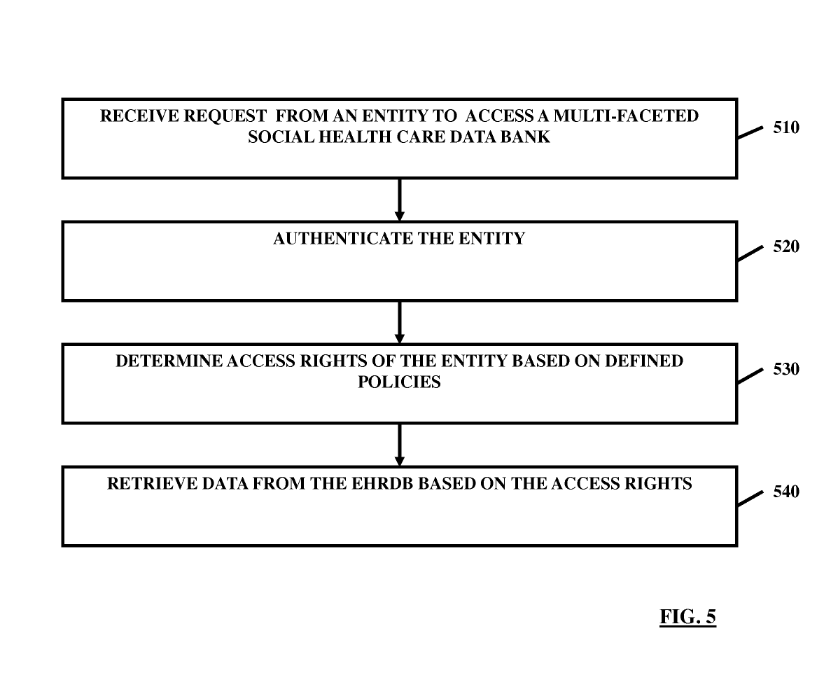

FIG. 5 illustrates a method flowchart for accessing the SHRDB 106 by an entity such as the entity 102₁. At step 510, the SHRDB 106 receives a request from the entity 102₁ for accessing the multi-faceted SHRDB 106. At step 520, the SHRDB 106 or the processing component 112 may authenticate the entity 102₁. Once authenticated, the SHRDB 106 determines access right of the entity 102₁ based on defined policies, rules and preferences such as those identified by the SHRDB 106 or pre-stored in the policy controller 114, at step 530. In some embodiments, the SHRDB 106 may retrieve the medical records from the repository as requested in the request of the entity 102₁, at step 540. The step of retrieving of the medical records may include at least one of sharing of the medical records either partially or fully to the entity 102₁ or to any other entity 102₂ of the plurality of entities 102 as suggested or authorized by the owner entity 102₁ and allowing viewing of the medical records at least partially by the entity 102₁ or 102₂.

In an embodiment, the method may include retrieving the social records, collected by the SHRDB 106 from several distinct locations such as distinct social aware networks or applications, by the social federation proxy 402 such as for displaying or presenting the social records to the entities 102. In an embodiment, the method allows the two way communication between the entities and the SHRDB 106 with the use of the social federation proxy 402. For example, the SHRDB can collect the social records from several social aware networks or applications such as through the entities 102 that are associated with the several social aware networks or the applications. The collected social records can be stored in a physical storage of the SHRDB 106. The social records thus stored in the SHRDB 106 can further be retrieved by the entities 102 and thus distributed across the various social aware networks or the applications through the social federation proxy 402.

In some embodiments, the method may also include determining a type of service to be provided to the entity 102₁ or 102₂ such as a service involving pure intermediated care, pure non-intermediated care, directed care, undirected care or a combination thereof as discussed above. Accordingly, the determined type of service may be initiated and provided to the entity 102₁ by the SHRDB 106 or in combination with third parties 406.

In an embodiment, the request from the entity 102₁ may further include an instruction to share at least a portion of the medical records to the entity 102₁ or the target location entity 102₂. In case of sharing with an entity other than the owner entity 102₁ such as the entity 102₂, the method may include sharing the at least a portion of the medical records based on at least one of (a) an explicit or implicit permission from the entity 102₁, (b) an indication of the extent of sharing, (c) a nature and characteristic of the target location entity 102₂, (d) a purpose of the sharing of the medical records to the target location entity 102₂, and (e) a timeframe for allowance of sharing of the medical records. In an embodiment, the step of sharing of the medical records with the target location 102₂ may include such as providing viewing rights to the target location 102₂ such that the method allows partial viewing of the at least a portion of the medical records by the target location 102₂ based on the one or more of (a) to (e) or stop any viewing or select which parts to view based on the one or more of (a) to (e), or determine or facilitate the entity 102₁ to determine who has viewed the medical records. In an embodiment, the method may include redefining the one or more of the (a) to (e). The method may include making a decision about the partial viewing of the at least a portion of the medical records by the target location entity 102₂ based on such as the one or more of (a) to (e) and the stopping of any viewing and selecting which parts to view based on the one or more of (a) to (e). Though parameters such as (a) to (e) are defined herein but it must be appreciated that other parameters may also be defined and considered without limitations.

The embodiments herein may be embodied as a computer program product configured to include a pre-configured set of instructions, which when performed, can result in actions as stated in conjunction with the method 400 and described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon. Such non-transitory computer readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

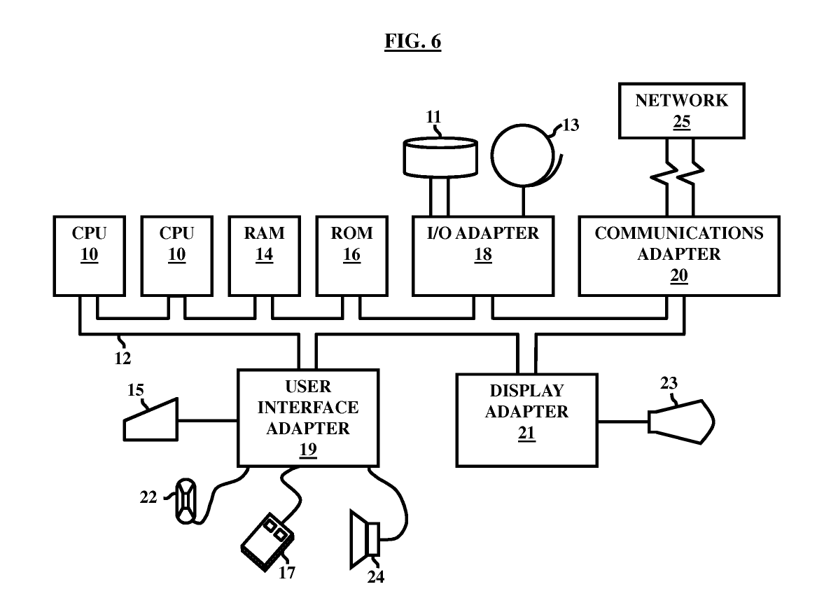

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for facilitating multi-faceted communication over a network, said system comprising:
a plurality of healthcare related entities each with a computing system connected with a communications network and associated with a plurality of social aware networks, wherein each of said plurality of healthcare related entities serve as a source of medical records;
a social health care record data bank (SHRDB) accessible by each of said plurality of entities based on rules and preferences of said entities upon authorization by said SHRDB, wherein said plurality of entities subscribe with said SHRDB to create, store, edit, manage or control said medical records, said SHRDB including:
a processing component capable of executing stored instructions to process said medical records of said entities over said communications network;
a repository included in or coupled to said SHRDB to store said medical records of said plurality of entities collected from the plurality of social aware networks;
a multi-faceted social health care component communicatively coupled to said SHRDB and adapted to be accessible by each of said plurality of entities such that said multi-faceted social health care component enables social interaction among said entities and said SHRDB over said communications network for medical records transfer or sharing; and
a social federation proxy communicatively coupled to said SHRDB and said communications network and configured to retrieve said medical records from said SHRDB collected from the social aware networks and distribute them to said plurality of social aware networks for display to said respective plurality of entities upon request.

2. The system of claim 1, wherein said system further comprising a policy controller that is configured to generate an output based on said rules and preferences of said plurality of entities, upon receipt of a request to access said SHRDB, said output used by said multi-faceted social health care component to authorize and control access of said plurality of entities.

3. The system of claim 2, wherein said system further comprising a report generator to generate said medical records and reports based on said generated medical records from said repository based on said request from said plurality of entities, wherein said reports can further be approved by said policy controller before sharing with said plurality of entities.

4. The system of claim 1, wherein said multi-faceted social health care component is configured to provide an interactive social user interface comprising a communication module to facilitate said plurality of entities to socially communicate with each other and with said SHRDB through an active social communication such that a social cloud or platform is implemented to communicate among said different entities and said SHRDB.

5. The system of claim 1, wherein said multi-faceted social health care component further comprises a natural language and speech recognition module to facilitate said plurality of entities to actively interact with each other and with said SHRDB through natural language and/or speech recognition techniques.

6. The system of claim 1, wherein said multi-faceted social health care component further comprises a social entity relationship management module that employs social entity relationship management techniques to build long-term relationships through said multi-faceted social health care component.

7. The system of claim 1, wherein said multi-faceted social health care component further comprises a single sign on scheme or module for a plurality of social electronic applications, wherein said social health care component is configured to integrate said plurality of entities with said plurality of social electronic applications through said single sign on scheme or module.

8. The system of claim 1, wherein said plurality of entities comprises a first entity, a second entity, a third entity, a fourth entity, and a fifth entity, wherein:
said first entity receives a purely intermediated care from said SHRDB or in combination with a third party;
said second entity receives a purely non-intermediated care from said SHRDB or in combination with a third party;
said third entity receives a purely directed care from said SHRDB or in combination with a third party;
said fourth entity receives a purely undirected care from said SHRDB or in combination with a third party; and
said fifth entity receives a customized service with a combination of two or more of said intermediated, non-intermediated, directed, and undirected care from said SHRDB or in combination with a third party.

9. The system of claim 1, wherein the SHRDB is configured to identify at least one source location and a target location, wherein said source location identifies medical records for sharing and said target location identifies an entity out of said plurality of entities as a recipient of said medical records defined by said source location, wherein at least one of said source location and said target is dependent on at least one of:
(a) an explicit or implicit permission from an owner of said source location;
(b) an indication of an extent of sharing;
(c) a nature and characteristic of said target location;
(d) a purpose of said sharing of said medical records to said target location; and
(e) a timeframe for allowance of sharing of said medical records,
wherein said at least one of said source location and said target location is automatically determined based on one or more of (a) to (e) upon receipt of a request from said owner entity or is predefined within said SHRDB by said owner entity.

10. The system of claim 9, wherein said sharing of said medical records with said target location includes providing viewing rights to said target location such that said SHRDB is configured to:
allow partial viewing of said medical records corresponding to said source location by said target location based on one or more of (a) to (e);
stop any viewing or select which parts to view based on one or more of (a) to (e); and
determine or facilitate said owner entity of said medical records to determine who has viewed said medical records and accordingly redefine said one or more of said (a) to (e) and also accordingly make a decision about said partial viewing of said medical records corresponding to said source location by said target location based on one or more of (a) to (e) and stopping of any viewing or selecting which parts to view based on said redefined one or more of (a) to (e).

11. The system of claim 10, wherein said social health care component is configured to identify who has viewed said medical records in real time and share information about who has viewed said medical records with the owner in real time, such that said owner allows fully or partially or stops viewing of said medical records by said target location in real time without predefining rules and guidelines for allowance and denial, wherein said allowance or denial by said owner is performed manually, further wherein said target location is allowed to view a ‘no objection’ segment of said medical records within a defined time after initiation of viewing if:
more than a time within which allowance or denial is made by said owner converts said ‘no objection’ viewing to viewing as decided or authorized by said owner, or
less than a time within which allowance or denial is made by said owner either extends the ‘no objection’ time by allowing more of medical records under ‘no objection’ viewing or repeats a previously viewed ‘no-objection’ segment of said medical records.

12. The system of claim 11, wherein said time and said medical records corresponding to said ‘no objection’ segment is further defined by said owner automatically or manually based on one or more of:
an explicit or implicit permission from an owner of said source location;
an indication of an extent of sharing;
a nature and characteristic of said target location;
a purpose of said sharing of said medical records to said target location; and
a timeframe for allowance of sharing of said medical records.

13. A system for facilitating multi-faceted communication over a network, said system comprising:
a plurality of healthcare related entities each with a computing system connected with a communications network, wherein each of said plurality of healthcare related entities serve as a source of medical records;
a social health care record data bank (SHRDB) accessible by each of said plurality of entities based on rules and preferences of said entities upon authorization by said SHRDB, wherein said plurality of entities subscribe with said SHRDB to create, store, edit, manage or control said medical records, said SHRDB including:
a processing component capable of executing stored instructions to process said medical records of said entities over said communications network;
a repository included in or coupled to said SHRDB to store said medical records of said plurality of entities;
a policy controller to authorize and control access of said plurality of entities based on said rules and respective preferences; and
a report generator to generate said medical records and reports based on said generated medical records from said repository based on said request from said plurality of entities; and
a multi-faceted social health care component communicatively coupled to said SHRDB and adapted to be accessible by each of said plurality of entities such that said multi-faceted social health care component enables social interaction among said entities and said SHRDB over said communications network for said medical records transfer or sharing,
wherein said multi-faceted social heath care component behaves as a centralized application and is adapted to automatically control display of said medical data based on said rules and said preferences, and
wherein said multi-faceted social health care component is adapted to interact with:
a first of said plurality of entities such that said first entity receives a purely intermediated care from said SHRDB or in combination with a third party;
a second of said plurality of entities such that said second entity receives a purely non-intermediated care from said SHRDB or in combination with a third party;
a third of said plurality of entities such that said third entity receives a purely directed care from said SHRDB or in combination with a third party;
a fourth of said plurality of entities such that said fourth entity receives a purely undirected care from said SHRDB or in combination with a third party; and
a fifth of said plurality of entities such that said fifth entity receives a combination of two or more of the intermediated, non-intermediated, directed, and undirected care from said SHRDB or in combination with a third party.

14. The system of claim 13, wherein said SHRDB is configured to identify at least one source location and a target location, wherein said source location identifies medical records for sharing and said target location identifies an entity out of said plurality of entities as a recipient of said medical records defined by said source location, wherein at least one of said source location and said target location is dependent on at least one of:
(a) an explicit or implicit permission from an owner of said source location;
(b) an indication of an extent of sharing;
(c) a nature and characteristic of said target location;
(d) a purpose of said sharing of said medical records to said target location; and
(e) a timeframe for allowance of sharing of said medical records,
wherein said at least one of said source location and said target location is automatically determined based on one or more of (a) to (e) upon receipt of a request from said owner entity or is predefined within said SHRDB by said owner entity.

15. The system of claim 14, wherein said sharing of said medical records with said target location includes providing viewing rights to said target location such that said SHRDB is configured to allow:
partial viewing of said medical records corresponding to said source location by said target location based on one or more of (a) to (e);
stop any viewing or select which parts to view based on one or more of (a) to (e); and
determine or facilitate said owner entity of said medical records to determine who has viewed said medical records and accordingly redefine said one or more of the (a) to (e) and also accordingly make a decision about said partial viewing of said medical records corresponding to said source location by said target location based on said redefined one or more of (a) to (e) and said stopping of any viewing or selecting which parts to view based on said redefined one or more of (a) to (e).

16. The system of claim 15, wherein said social health care component is configured to identify who has viewed said medical records in real time and share information about who has viewed said medical records with said owner in real time, such that said owner allows fully or partially or stops viewing of said medical records by said target location in real time without predefining rules and guidelines for allowance and denial, wherein said allowance or denial by said owner is performed manually, further wherein said target location is allowed to view a ‘no objection’ segment of said medical records within a defined time after initiation of viewing if:
more than a time within which allowance or denial is made by said owner converts said ‘no objection’ viewing to viewing as decided or authorized by said owner, or
less than a time within which allowance or denial is made by said owner either extends said ‘no objection’ time by allowing more of medical records under ‘no objection’ viewing or repeats a previously viewed ‘no-objection’ segment of the medical records.

17. A method for accessing a social health record data bank (SHRDB) by an entity, said method comprising:
receiving a request from said entity for accessing said SHRDB;
authenticating said entity;
determining access rights of said entity based on rules and preferences;
retrieving medical records from a repository of said SHRDB as requested by said entity in said request, wherein retrieving of said medical records include at least one of sharing of said medical records either partially or fully to said entity and allowing viewing of said medical records at least partially by said entity;
determining a type of service to be provided to said entity in association with said sharing of said medical records or allowing viewing of said medical records by said entity, wherein said service includes at least one of a pure intermediated care, pure non-intermediated care, pure directed care, and pure undirected care, said service being provided by said SHRDB or in combination with a third party,
wherein said request from said entity further includes an instruction to share at least a portion of said medical records to a target location entity, said method including:
sharing said at least a portion of said medical records to said target location based on at least one of:
(a) an explicit or implicit permission from said entity;
(b) an indication of an extent of sharing;
(c) a nature and characteristic of said target location entity;
(d) a purpose of said sharing of said medical records to said target location entity; and
(e) a timeframe for allowance of sharing of said medical records, said sharing of said medical records with said target location including providing viewing rights to said target location such that said method allows:
partial viewing of said at least a portion of said medical records by said target location based on one or more of (a) to (e);
stop any viewing or select which parts to view based on one or more of (a) to (e); and
determine or facilitate said entity to determine who has viewed said medical records.

18. The method of claim 17 further comprising:
redefining said one or more of said (a) to (e);
making a decision about said partial viewing of said at least a portion of said medical records by said target location entity based on said redefined one or more of (a) to (e) and said stopping of any viewing and selecting which parts to view based on said redefined one or more of (a) to (e).

19. A non-transitory program storage device readable by computer, and comprising a program of instructions executable by said computer to perform a method for accessing a social health record data bank (SHRDB) by an entity, said method comprising:
receiving a request from said entity for accessing said SHRDB;
authenticating said entity;
determining access rights of said entity based on rules and preferences;
retrieving medical records from a repository of said SHRDB as requested by said entity in said request, wherein retrieving of said medical records include at least one of sharing of said medical records either partially or fully to said entity and allowing viewing of said medical records at least partially by said entity;
determining a type of service to be provided to said entity in association with said sharing of said medical records or allowing viewing of said medical records by said entity, wherein said service includes at least one of a pure intermediated care, pure non-intermediated care, pure directed care, and pure undirected care, said service being provided by said SHRDB or in combination with a third party,
wherein said request from said entity further includes an instruction to share at least a portion of said medical records to a target location entity, said method including:
sharing said at least a portion of said medical records to said target location based on at least one of:
(a) an explicit or implicit permission from said entity;
(b) an indication of an extent of sharing;
(c) a nature and characteristic of said target location entity;
(d) a purpose of said sharing of said medical records to said target location entity; and
(e) a timeframe for allowance of sharing of said medical records, said sharing of said medical records with said target location including providing viewing rights to said target location such that said method allows:
partial viewing of said at least a portion of said medical records by said target location based on one or more of (a) to (e);
stop any viewing or select which parts to view based on one or more of (a) to (e); and
determine or facilitate said entity to determine who has viewed said medical records.

20. The program storage of claim 19, wherein said method further comprising:
redefining said one or more of said (a) to (e);
making a decision about said partial viewing of said at least a portion of said medical records by said target location entity based on said redefined one or more of (a) to (e) and said stopping of any viewing and selecting which parts to view based on said redefined one or more of (a) to (e).
